(19) United States
(12) Patent Application Publication
(10) Pub. No.: US 2023/0166170 A1
(43) Pub. Date: Jun. 1, 2023

(54) Swimming machine

(71) Applicants: Daniel Phillips, Devon (GB); Lighthouse Pools, Devon (GB)

(72) Inventor: Daniel PHILLIPS, Devon (GB)

(21) Appl. No.: 18/052,241

(22) Filed: Nov. 3, 2022

(30) Foreign Application Priority Data
Nov. 3, 2021 (GB) GB2115917.3

(51) Int. Cl. A63B 69/12

(52) U.S. Cl. CPC A63B 69/125

(57) ABSTRACT

A swimming machine comprising a housing adapted to be mounted to an interior wall of a swimming pool. The housing comprising a hydraulic motor connected to an impellor mounted within the housing for producing a current of water in the pool when in use. The swimming machine further comprising a hydraulic pump stored outside the housing operably connected to the hydraulic motor mounted within the housing, an electric motor connected to and powering the hydraulic pump, an inverter drive system connected to, powering and controlling the electric motor. Wherein in use the speed of the current produced is controlled by the inverter drive system.

The present invention relates to a swimming machine to allow a person to swim in a swimming pool against a current. Specifically, the present invention relates to a swimming machine which can be used in a swimming pool, of a size typically not large enough to properly swim continuously in, to allow a person to swim continuously against a current. More specifically, the present invention relates to a swimming machine which may be retrofitted to a swimming pool which allows a person to swim continuously against a current.

### BACKGROUND OF THE INVENTION

Most swimming pools are not suitable for swimming in because of the relatively small size of the pools. The length of the pools means that any individual swimming therein, setting off from one side, can only make a small number of full strokes before reaching the opposing side and having to turn around. This is very disruptive to the individual trying to exercise. And can even increase the risk of injury, with the chance of the individual colliding with the internal edge of the pool.

Swimming machines address this problem by producing a current within the swimming pool for the individual to swim against while remaining stationary with relation to the pool, allowing for uninterrupted distance swimming within a small swimming pool.

One problem that existed with existing swimming machines was powering the motor within the swimming pool without the risk of electrical fault causing a serious accident.

One solution to this problem was the use of a hydraulic motor within the swimming pool, the motor being powered by a hydraulic pump external from the pool, the pump being powered by an electric motor. The operating strength of the hydraulic motor being controlled by an individual via a proportional flow valve in the hydraulic oil system. This however means that the electric motor driving the pump is always operating at full speed and therefore has a reduced lifespan.

The other problem of prior art swimming machines that use hydraulic motors is that the hydraulic motor can also be worn down by constant exposure to the pool water and chemicals therein.

It is an object of the current invention to provide a swimming machine which addresses the problems raised above.

### STATEMENT OF INVENTION

According to a first aspect of the invention there is provided a swimming machine comprising a housing adapted to be mounted to an interior wall of a swimming pool. The housing comprising a hydraulic motor connected to an impellor mounted within the housing for producing a current of water in the pool when in use. The swimming machine further comprising a hydraulic pump stored outside the housing operably connected to the hydraulic motor mounted within the housing, an electric motor connected to and powering the hydraulic pump, an inverter drive system connected to, powering and controlling the electric motor. Wherein in use the speed of the current produced is controlled by the inverter drive system.

An embodiment of the first aspect, wherein the hydraulic motor is encased in resin to make it waterproof. The resin can be an epoxy resin and can have a chemical resistant gel topcoat.

An embodiment of the first aspect, wherein the electric motor is a 4 kW 3 phase motor.

An embodiment of the first aspect, wherein the inverter drive system is a single phase to three phase inverter drive system.

An embodiment of the first aspect, wherein the hydraulic motor is a 50 CC hydraulic motor.

An embodiment of the first aspect, wherein the impellor has approximately a 42 cm2 area.

An embodiment of the first aspect, wherein the inverter drive system is connected to a controller which is controlled by a user via keypad. The keypad may be distal to the controller and both comprise a transmitter/receiver for wireless communication.

An embodiment of the first aspect, wherein the housing is substantially made from a fiberglass composite.

An embodiment of the first aspect, wherein mounted within the housing there is an array of turning vanes for directing the water flow produced by the impellor to a substantially horizontal direction. The housing may further comprise two water diffusers mounted in the housing, the first mounted between the impellor and the array of turning vanes, the second mounted in.

a wall of the housing on a side of the array of the tuning vanes distal the first diffuser.

### BRIEF DESCRIPTION OF THE FIGURES

FIG. 1 depicts a schematic view of the machine and a diagram of the hydraulic circuit;

FIG. 2 depicts an exploded view of an embodiment of the invention;

FIG. 3 depicts an embodiment of the remote module of the invention;

FIGS. 4 and 5 depict schematic embodiments of the invention.

### DETAILED DESCRIPTION

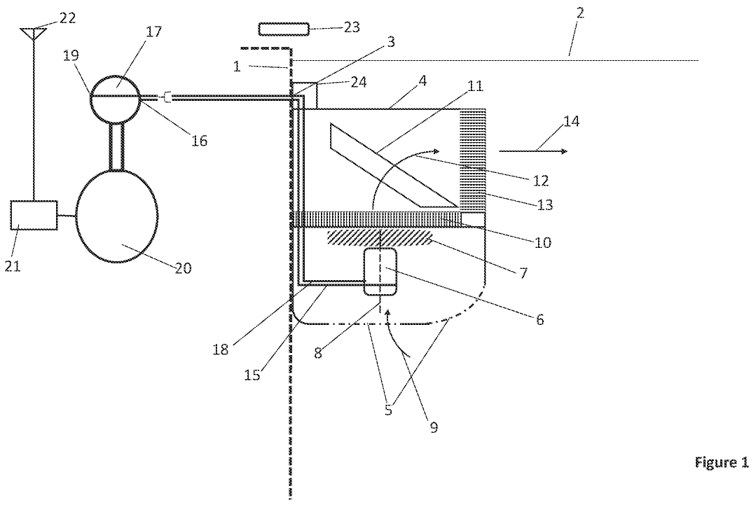

The swim jet of the present invention as shown in FIG. 1 comprises two main parts. A head unit located within the pool and power pack situated outside the pool. The head unit is installed on a wall 1 of a swimming pool. It can either be installed at the construction of the pool or retrofitted to an existing pool. The swim jest is located just below the surface 2 of the pool water and is fixed to an interior wall 1 of the swimming pool and is connected by a mounting bracket 3 to the pool wall 1.

The head unit itself comprises a housing 4 which encases the whole head unit, preferably made from a fiberglass composite. The lower half of the head unit comprises at least one preferably more inlets 5 which allow pool water from a deeper portion of the pool to enter the housing. Held in the lower half of the head unit is a hydraulic motor 6 attached to an impeller 7, the motor 6 urging the impeller 7 to rotate about a rotation axis 8. The rotation axis 8 being substantially vertical/parallel with the pool wall 1.

The spinning impellor 8 sucks water in through the inlets 5 via path roughly indicated by arrow 9, and then urges the water up into the upper half of the head unit.

Just above the impellor 7 is a first water diffuser 10, preferably made from plastic, to straighten the water current urged by impellor 7 as it enters the upper half of the head unit such that the flow of the water current is substantially laminar in a vertical direction. The vertical laminar flow of water than passes through an array of turning vanes 11. The array of turning vanes 11, turn the substantially vertical water flow such that the direction of the water flow is now substantially horizontal in a direction into the pool. The water flow as it passes through the array of turning vanes 11 is roughly shown by arrow 12.

The now substantially horizontal water flow passes through a second diffuser 13 to straighten the flow of the water as it leaves the upper half of the head unit. This then creates the continuous horizontal laminar flow current of water 14 which a user can swim against.

The hydraulic motor 6 is preferably a 50 CC hydraulic motor which runs the impeller 7 which is preferably a 42 cm² impeller. The hydraulic motor is also preferably encapsulated in a chemical resistant resin to protect it from the pool water and increase its lifespan. The motor 6 in the head unit is encapsulated by spraying 3 layers of a fine coating of epoxy resin, and using a fast acting curing agent. This is then completed with a top coat using a chemical resistant coloured gel coat for extra protection. The benefit of this encapsulation is it waterproofs the motor 6 but still allows it to dissipate heat to the pool water and keep cool, therefore increasing the lifespan of the motor 6.

Hydraulic fluid feed line 15 for the hydraulic motor 6 is connected to the high-pressure outlet 16 of hydraulic power pack 17. Hydraulic outlet line 18 of the hydraulic motor 6 is connected to the inlet 19 for the hydraulic power pack 17.

Hydraulic lines 15 and 18 go from the hydraulic motor 6 up through housing 4 until they pass through the top of housing 4, at this point they turn and go into the pool wall 1, either through our proximal brackets 3. Brackets 3 and pipes 15 and 18 are covered by a bespoke cap 24 which hides the pipes 15, 18 and mounting bracket 3 from view.

The hydraulic power pack preferably comprises a motor (preferably a 4 kW three phase motor), a hydraulic pump powered by the motor, a reservoir for the hydraulic fluid, a filler filter, a level gauge, and a pressure gauge with a safety by-pass. The 4 kW three phase motor is powered by a single phase to three phase inverter drive system 20.

The inverter drive system 20 regulates the speed of the motor within the hydraulic power pack 17, which therefore controls the amount of power given to the hydraulic motor 6, which ultimately then controls the speed of the horizontal flow of water 14 which is swam against by a user.

Calibration and control of the inverter drive system can be done by a controller 21 connected to the inverter drive system 20. The controller 21 can be controlled by a user via a built-in keypad, alternatively or additionally the controller 21 can also be connected to a transmitter/receiver 22 (preferably a RF radio transmitter/receiver). Transmitter/receiver 22 communicates with user remote control 23.

Using inverter drive system 20 to control the motor speed of hydraulic power pack 17 to in turn control and regulate the speed of water flow 14 via hydraulic motor 6 is intrinsically better than traditional swim machines which instead control the speed of water flow via use of a proportional relief valve in the hydraulic system. This is because firstly the system of the current invention is more energy efficient as the motor driving the hydraulic pump only runs to the required speed rather than running near full speed constantly. Also the inverter drive system, even when running at full speed is more efficient than traditional drive systems.

Secondly, the user experience is better as there is less noise from the motor driving the hydraulic pump as it is not constantly running at full speed. And the user has greater control of the flow speed via the inverter drive system over control of a proportional flow valve of the traditional systems.

Thirdly the system of the current invention has a longer life span than traditional swim machine systems, the motor driving the hydraulic pump not running at full speed whenever in use increases the lifespan of the motor, and the hydraulic motor being encapsulated in resin, unlike traditional swim systems means that the hydraulic motor in the head unit also has a longer lifespan and does not need to be replaced as often.

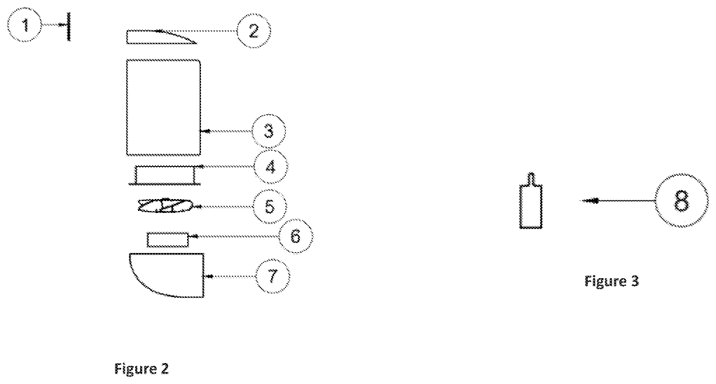

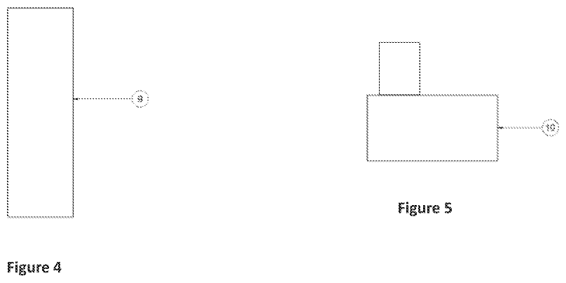

With regards to FIGS. 2 to 5 which depict a schematic and layout of the invention. FIG. 2 shows an exploded view of an embodiment of the invention. there is the mounting bracket 1 which attaches the invention to the inside wall of a swimming pool. This is covered from view by top cover 2. Main body 3 is the housing which encases the majority of the parts of the invention. propeller housing 4 holds and protects propellor 5. Propeller 5 is in turn connected to motor 6 which is encased in resin. On the bottom of main body 3 is filter section 7 which allows pool. water to be drawn into the invention. FIG. 2 shows a preferred shape of a remote-control unit 8. FIGS. 4 and 5 show the inverter controller 9 and the hydraulic power pack 10 respectively.

The invention has been described with reference to a preferred embodiment. The description is intended to enable a skilled person to make the invention, not to limit the scope of the invention. The scope of the invention is determined by the claims.

1. A swimming machine comprising:
A housing adapted to be mounted to an interior wall of a swimming pool, the housing comprising: a hydraulic motor connected to an impellor mounted within the housing for producing a current of water in the pool when in use;
A hydraulic pump stored outside the housing operably connected to the hydraulic motor mounted within the housing;
An electric motor connected to and powering the hydraulic pump;
An inverter drive system connected to, powering and controlling the electric motor;
Wherein in use the speed of the current produced is controlled by the inverter drive system.

2. A swimming machine according to claim 1 wherein the hydraulic motor is encased in resin to make it waterproof.

3. A swimming machine according to any preceding claim wherein the electric motor is a 4 kW 3 phase motor.

4. A swimming machine according to any preceding claim wherein the inverter drive system is a single phase to three phase inverter drive system.

5. A swimming machine according to any preceding claim, wherein the hydraulic motor is a 50 CC hydraulic motor.

6. A swimming machine according to any receding claim, wherein the impellor has approximately a 42 cm2 area.

7. A swimming machine according to any preceding claim wherein the inverter drive system is connected to a controller which is controlled by a user via keypad.

8. A swimming machine according to claim 7 wherein the keypad is distal to the controller and both comprise a transmitter/receiver for wireless communication.

9. A swimming machine according to any preceding claim wherein the housing is substantially made from a fiberglass composite.

10. A swimming machine according to any preceding claim wherein mounted within the housing there is an array of turning vanes for directing the water flow produced by the impellor to a substantially horizontal direction.

11. A swimming machine according to claim 10 further comprising two water diffusers mounted in the housing, the first mounted between the impellor and the array of turning vanes, the second mounted in a wall of the housing on a side of the array of the tuning vanes distal the first diffuser.

12. A swimming machine according to claim 2, wherein the chemical resistant resin is an epoxy resin.

13. A swimming machine according to claim either one of claim 2 or 12 wherein the resin coating additionally has a chemical resistant gel top coat.
